(19) United States
(12) Patent Application Publication
(10) Pub. No.: US 2012/0262252 A1
(43) Pub. Date: Oct. 18, 2012

(54) BAND-PASS FILTER

(75) Inventors: PING CHIN TSENG, Hsinchu City (TW); HONG RU SUCHEN, Hsinchu City (TW)

(73) Assignee: MICROELECTRONICS TECHNOLOGY INC., Hsinchu (TW)

(21) Appl. No.: 13/087,721

(22) Filed: Apr. 15, 2011

(51) Int. Cl. H01P 1/205

(52) U.S. Cl. 333/203

(57) ABSTRACT

A band-pass filter comprises a first resonator, a second resonator and a third resonator. The second resonator is magnetically coupled to the first resonator. The third resonator is magnetically coupled to the second resonator and is electrically coupled to the first resonator. In addition, the first resonator is a quarter wavelength resonator, the second resonator is a half wavelength resonator, and the third resonator is a quarter wavelength resonator.

### BACKGROUND OF THE INVENTION

1. Field of the Invention

The present invention relates to filter design, and more particularly, to band-pass filter design.

2. Description of the Related Art

In typical receiver architecture, as shown in FIG. 1, when a receiver 100 receives a radio frequency (RF) signal with frequency f_{R}, the received RF signal is amplified by an RF antenna 101. Next, a mixer 102 and a local to oscillator (LO) 103 are utilized to shift the frequency of the received RF signal to an intermediate frequency fₗ for the subsequent signal processing. The LO 103 is configured to provide an LO signal with an adjustable frequency f_{O}. The mixer 102 is configured to perform a multiplying operation for the received RF signal and the LO signal to produce new is signals of beat frequencies of f_{R}+f_{O} and f_{R}−f_{O}. Ordinarily, the signal of frequency f_{R}−f_{O} is the desired signal, wherein the frequency f_{R}−f_{O} equals the intermediate frequency fₗ, and the signal with frequency f_{R}+f_{O} is the unwanted signal.

However, the RF antenna 101 may also receive image signals with image frequency f_{W}, wherein the image frequency f_{W} equals f_{O}−Fₗ. Accordingly, after the operation of the mixer 102, the image signals are also shifted to the intermediate frequency fₗ since new signals of beat frequencies of f_{O}+f_{W} and f_{O}−f_{w} are also produced, wherein the frequency of f_{O}−f_{W} equals the intermediate frequency fₗ. As a result, the image signals will cause interferences with the received RF signal. Therefore, a band-pass filter 104 is often required to eliminate the image signals, as shown in FIG. 1.

One conventional band-pass filter structure is shown in FIG. 2. The band-pass filter 200 uses a hairpin structure. Another conventional band-pass filter structure is shown in FIG. 3. The band-pass filter 300 uses an inter-digital structure. FIG. 4 shows the frequency responses of the band-pass filters 200 and 300. As shown in FIG. 4, the hairpin band-pass filter 200 exhibits a steeper slope at the lower side of the pass band, i.e. the frequency band of the image signal, and a smaller gain at the pass band compared to the inter-digital band-pass filter 300. Accordingly, the hairpin band-pass filter 200 has a better image rejection capability at the lower side of the passband but a poor insertion loss compared to the inter-digital hand-pass filter 300. On the other hand, the inter-digital band-pass filter 300 has a poor image rejection capability but a better insertion loss compared to the hairpin band-pass filter 200. In addition, as shown in FIGS. 2 and 3, the hairpin band-pass filter 200 requires more layout area.

Accordingly, neither the hairpin band-pass filter 200 shown in FIG. 2 nor the inter-digital band-pass filter 300 shown in FIG. 3 meets the requirements of modem band-pass filter design.

### SUMMARY OF THE INVENTION

The band-pass filter according to one embodiment of the present invention comprises a first resonator, a second resonator and a third resonator. The second resonator is magnetically coupled to the first resonator. The third resonator is magnetically coupled to the second resonator and is electrically coupled to the first resonator. In addition, the first resonator is a quarter wavelength resonator, the second resonator is a half wavelength resonator, and the third resonator is a quarter wavelength resonator.

The band-pass filter according to another embodiment of the present invention comprises a plurality of half wavelength resonators and a plurality of quarter wavelength resonators. The plurality of half wavelength resonators and the plurality of quarter wavelength resonators are arranged along a first direction in an interleaved manner, and each of the two ends of the band-pass filter is arranged with a quarter wavelength resonator.

The foregoing has outlined rather broadly the features and technical advantages of the present invention in order that the detailed description of the invention that follows may be better understood. Additional features and advantages of the invention will be described hereinafter, and form the subject of the claims of the invention. It should be appreciated by those skilled in the art that the conception and specific embodiment disclosed may be readily utilized as a basis for modifying or designing other structures or processes for carrying out the same purposes as those of the present invention. It should also be realized by those skilled in the art that such equivalent constructions do not depart from the spirit and scope of the invention as set forth in the appended claims.

### BRIEF DESCRIPTION OF THE DRAWINGS

The objectives and advantages of the present invention will become apparent upon reading the following description and upon referring to the accompanying drawings of which:

FIG. 1 shows a partial block diagram of typical receiver architecture;

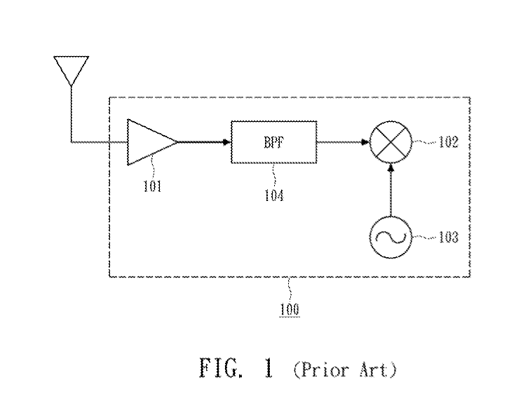

FIG. 2 shows a conventional band-pass filter structure;

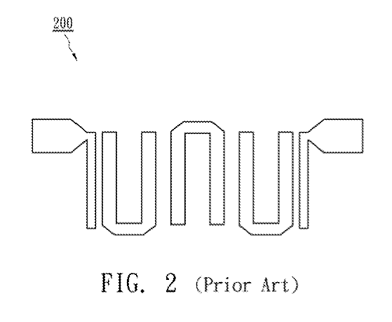

FIG. 3 shows another conventional band-pass filter structure;

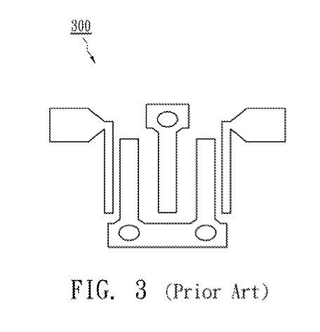

FIG. 4 shows the frequency responses of two conventional band-pass filters;

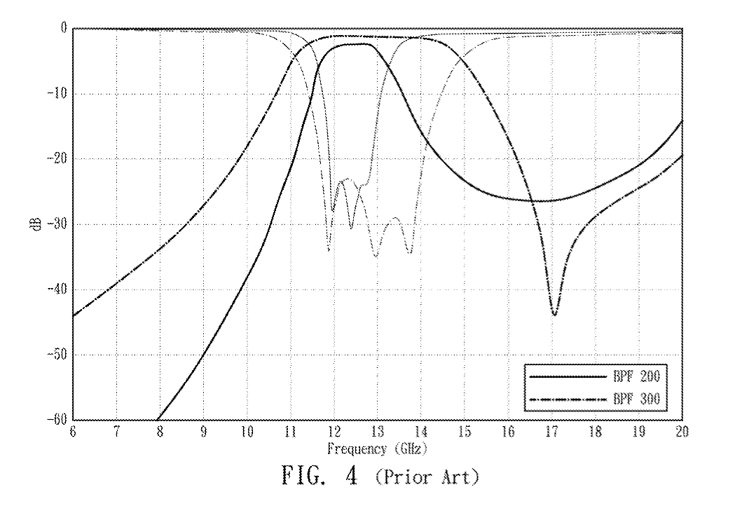

FIG. 5 shows a band-pass filter structure according to an embodiment of the present invention;

FIG. 6 shows a coupling diagram of a band-pass filter according to an embodiment of the present invention;

FIG. 7 shows the frequency responses of two conventional band-pass filters and a band-pass filter according to an embodiment of the present invention;

FIG. 8 shows a band-pass filter structure according to another embodiment of the present invention; and

FIG. 9 shows a band-pass filter structure according to another embodiment of the present invention.

### DETAILED DESCRIPTION OF THE INVENTION

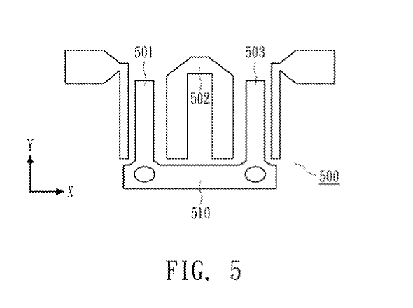

FIG. 5 shows a band-pass filter structure according to an embodiment of the present invention. As shown in FIG. 5, the band-pass filter 500 comprises a first resonator 501, a second resonator 502 and a third resonator 503. The first resonator 501, the second resonator 502 and the third resonator 503 are arranged along the X-direction with the second resonator 502 sandwiched between the first resonator 501 and the third resonator 503. The first resonator 501 and the third resonator 503 are both quarter wavelength resonators. That is, the lengths of the first resonator 501 and the third resonator 503 are a quarter of the wavelength of the electromagnetic wave received by the band-pass filter 500. In addition, both the first resonator 501 and the third resonator 503 are in a long strip shape extending along the Y-direction. Further, both the first resonator 501 and the third resonator 503 have one end connected to a ground line 510. The second resonator 502 is a half wavelength resonator. That is, the length of the second resonator 502 is half of the wavelength of the electromagnetic wave received by the band-pass filter 500. In addition, the second resonator 502 is in a U shape with the opening facing the ground line 510.

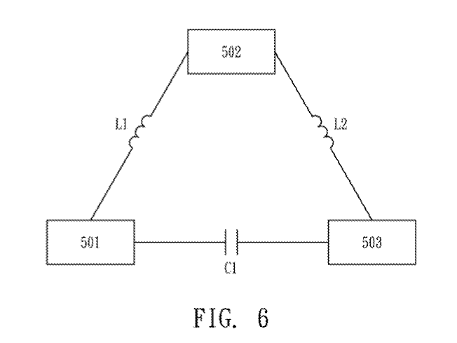

FIG. 6 shows a coupling diagram of the band-pass filter 500 shown in FIG. 5. As shown in FIG. 6, the magnetic coupling between the first resonator 501 and the second resonator 502 is strong. Accordingly, the coupling between the first resonator 501 and the second resonator 502 is represented by an inductance L1. Likewise, the magnetic coupling between the second resonator 502 and the third resonator 503 is also strong. Therefore, the coupling between the second resonator 502 and the third resonator 503 is represented by an inductance L2. However, the magnetic coupling between the first resonator 501 and the third resonator 503 is weak and the electric coupling dominates the coupling between both resonators. Accordingly, the first resonator 501 and the third resonator 503 is represented by a conductance C1.

It can be seen that when the band-pass filter 500 is operated below resonance, the phase of the first path, which is from the first resonator 501 to the third resonator 503 passing through the second resonator 502, is −90 degrees. On the other hand, the phase of the second path, which is from the first resonator 501 directly to the third resonator 503, is 90 degrees. That is, when the band-pass filter 500 is operated below resonance, the first path and the second path are out of phase, which accordingly introduces a transmission zero at the lower side of the pass band of the band-pass filter 500.

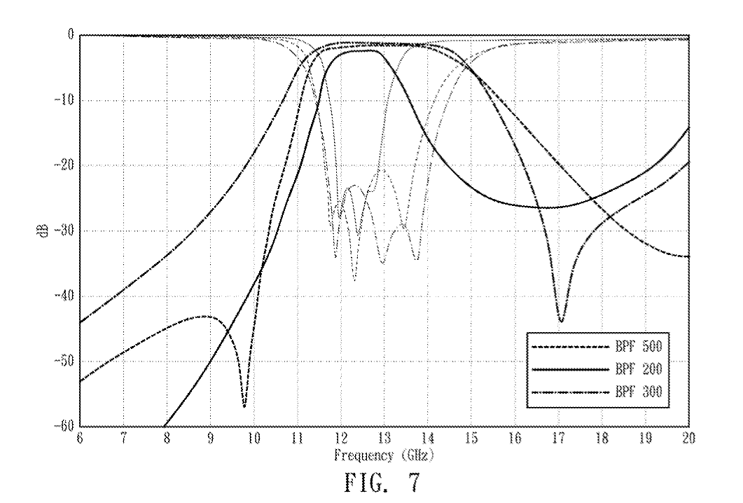

FIG. 7 shows the frequency responses of the band-pass filters 200, 300 and 500. As shown in FIG. 7, the frequency response of the band-pass filter 500 has a transmission zero at the lower side of the pass band, which produces a steep slope at the lower side of the pass band. Accordingly, the band-pass filter 500 has a great image rejection capability. In addition, as shown in FIG. 7, the band-pass filter 500 also exhibits a small insertion loss.

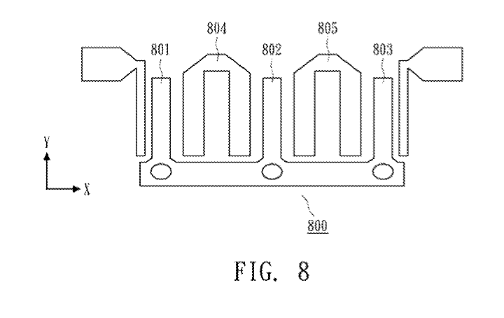

FIG. 5 shows a three-order band-pass filter 500. However, the present invention is not limited to a three-order band-pass filter, and should cover any other higher-order band-pass filters with the same structure concept. FIG. 8 shows a band-pass filter structure according to another embodiment of the present invention. As shown in FIG. 8, the band-pass filter 800 comprises three quarter wavelength resonators 801, 802 and 803 and two half wavelength resonators 804 and 805. The three quarter wavelength resonators 801, 802 and 803 and the two half wavelength resonators 804 and 805 are arranged along the X-direction in an interleaved manner with each of the two ends of the hand-pass filter 800 arranged with a quarter wavelength resonator 801 and 803 respectively. Accordingly, the band-pass filter 800 is a five-order band-pass filter.

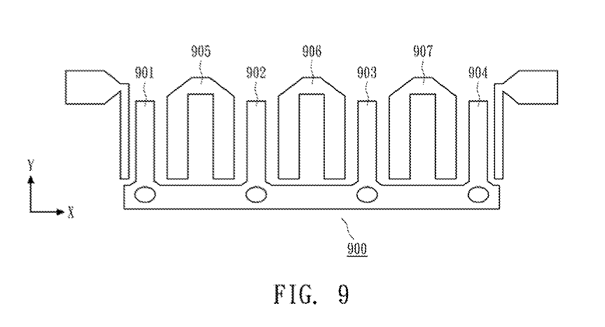

FIG. 9 shows a band-pass filter structure according to yet another embodiment of the present invention. As shown in FIG. 9, the band-pass filter 900 comprises four quarter wavelength resonators 901, 902, 903 and 904 and three half wavelength resonators 905, 906 and 907. The four quarter wavelength resonators 901, 902, 903 and 904 and the three half wavelength resonators 905, 906 and 907 are arranged along the X-direction in an interleaved manner with each of the two ends of the band-pass filter 900 arranged with a quarter wavelength resonator 901 and 904 respectively. Accordingly, the band-pass filter 900 is a seven-order band-pass filter.

In conclusion, the present invention provides band-pass filters exhibiting great image rejection capability and small insertion loss. In addition, the layout areas of the band-pass filters provided by the present invention can meet the requirement of the modern filter design. Therefore, the band-pass filters provided by the present invention are suitable for the low noise block specified in North American standard, i.e. the frequency band between 12.2 GHz and 12.7 GHz, and the low noise block specified in European standard, i.e. the frequency band between 10.7 GHz and 12.75 GHz.

Although the present invention and its advantages have been described in detail, it should be understood that various changes, substitutions and alterations can be made herein without departing from the spirit and scope of the invention as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A band-pass filter, comprising:
a first resonator;
a second resonator magnetically coupled to the first resonator; and
a third resonator magnetically coupled to the second resonator and electrically coupled to the first resonator;
wherein the first resonator is a quarter wavelength resonator, the second resonator is a half wavelength resonator, and the third resonator is a quarter wavelength resonator.

2. The band-pass filter of Claim I, wherein both the first resonator and the third resonator are in a long strip shape extending along a first direction.

3. The band-pass filter of claim 2, wherein the first resonator, the second resonator and the third resonator are aligned along a second direction perpendicular to the first direction with the second resonator sandwiched between the first resonator and the third resonator.

4. The band-pass filter of claim 3, wherein both the first resonator and the third resonator have a lower end connected to a ground side.

5. The band-pass filter of claim 4, wherein the second resonator is in a U shape with an opening facing the ground side.

6. The band-pass filter of claim 1, wherein the first resonator and the third resonator are grounded.

7. The band-pass filter of claim 1, wherein the second resonator is in a U shape.

8. The band-pass filter of claim 1, the frequency response of which has a transmission zero at a lower side of the pass band.

9. The band-pass filter of claim 1, which is applied to a radio frequency system with a frequency band between 10.7 GHz and 12.75 GHz.

10. The band-pass filter of claim 1, which is applied to a radio frequency system with a frequency band between 12.2 GHz and 12.7 GHz.

11. A band-pass filter, comprising:
a plurality of half wavelength resonators; and
a plurality of quarter wavelength resonators;
wherein the plurality of half wavelength resonators and the plurality of quarter wavelength resonators are arranged along a first direction in an to interleaved manner with each of two ends of the band-pass filter arranged with a quarter wavelength resonator.

12. The band-pass filter of claim 11, wherein each of the quarter wavelength resonators is in a long strip shape extending along a second direction perpendicular to the first direction.

13. The band-pass filter of claim 11, wherein each of the quarter wavelength resonators has a lower end connected to a ground side.

14. The band-pass filter of claim 13, wherein each of the half resonators is in a U shape with an opening facing the ground side.

15. The band-pass filter of claim 11, wherein each of the half resonators is in a U shape.

16. The band-pass filter of claim 11, the frequency response of which has a transmission zero at a lower side of the pass band.

17. The band-pass filter of claim 11, wherein each of the plurality of quarter wavelength resonators is magnetically coupled to at least one of the plurality of half wavelength resonators.

18. The band-pass filter of claim 11, wherein each of the plurality of quarter wavelength resonators is electrically coupled to at least one of the other quarter wavelength resonators.

19. The band-pass filter of claim 11, which is applied to a radio frequency system with a frequency band between 10.7 GHz and 12.75 GHz.

20. The band-pass filter of claim 11, which is applied to a radio frequency system with a frequency band between 12.2 GHz and 12.7 GHz.
